(19) United States
(12) Patent Application Publication
(10) Pub. No.: US 2023/0074454 A1
(43) Pub. Date: Mar. 9, 2023

(54) Method And Apparatus For External Operation Of Computing Program Or Application

(71) Applicant: Laxcen Technology Limited, Hong Kong (CN)

(72) Inventors: Feng LU, Hong Kong (CN); Haitao SI, Hong Kong (CN)

(21) Appl. No.: 17/469,885

(22) Filed: Sep. 9, 2021

(51) Int. Cl. A63F 3/04; A63F 9/24; G06K 7/10

(52) U.S. Cl. CPC A63F 3/0421; A63F 9/24; G06K 7/10297; G06K 7/10366; A63F 2009/2489

(57) ABSTRACT

An apparatus, which is configured for external operation of a computer program or application installed into a computerized device, includes a reader tray and a plurality of tag modules. The reader tray, having a plurality of identification areas, includes a reader module and a communication module for communicatively connecting to the computerized device that stores and executes the computer program or application. Each of the tag modules stores one or more predetermined tag information, wherein when the tag modules are selectively placed on the identification areas, the reader module reads the tag information of the tag modules to generate an output signal in response to a location sequence of the tag modules for operating the computer program or application through the communication module.

### NOTICE OF COPYRIGHT

A portion of the disclosure of this patent document contains material which is subject to copyright protection. The copyright owner has no objection to any reproduction by anyone of the patent disclosure, as it appears in the United States Patent and Trademark Office patent files or records, but otherwise reserves all copyright rights whatsoever.

### BACKGROUND OF THE PRESENT INVENTION

### Field of Invention

The present invention relates to a computer program or application, and more particularly to a method and apparatus for external operation of the computer program or application, which comprises a reader tray and a plurality of tag modules selectively placed thereon to generate an output signal in response to a location sequence of the tag modules for externally operating the computer program or application.

### Description of Related Arts

With the advent of the Internet, life has suddenly become much faster. Information, business, and even entertainment are just a click of a mouse away. With the Internet has come the opportunity for greater stimulation, communication networks become one of an essential components for children educational games and intelligent interactive toys. Via the communication networks, these games and toys are configured to increase children's learning interest, to develop children's critical thinking, and to enhance children's hand-on abilities.

The existing games are generally categorized into three different types, i.e. a standalone interactive game, a judging interactive game, and an interconnected interactive game. Accordingly, the standalone interactive game is configured to have a reading module and a tag module, wherein the reading module is able to read information stored in the tag module and to execute corresponding instructions for interacting with the user. The judging interactive game, such as a board game, is configured to have an identification and reading module, and two or more tag modules selectively linked to the identification and reading module, wherein the identification and reading module is able to determine and prompt each tag module or comply the game rules in response to the tag module. The interconnected interactive game is configured to have a reading module, a tag module, and a mobile smart device. The reading module is arranged to read the information of the tag module and to send a feedback to the mobile smart device, wherein the mobile smart device is able to generate a video and/or audio signal in response to the information of the tag module.

The above three interactive games generally incorporate the reading module to identify the single tag module and output the information of the single tag module to the mobile smart device. However, the logical relationship of these interactive games is simple and straight forward, wherein the tag module provides one to one function, such that when inputting the information of the tag module, the reading module will only generate one single output correspondingly. Even though different information can be provided by different tag modules respectively, the multiple tag modules can only be limited to a particular game such as board game and can only be used according to the game rules. In other words, the existing interactive games provide limited interactive for the user, such that the user will loss the learning interest easily.

### SUMMARY OF THE PRESENT INVENTION

The invention is advantageous in that it provides a method and apparatus for external operation of the computer program or application, which comprises a reader tray and a plurality of tag modules selectively placed thereon to generate an output signal in response to a location sequence of the tag modules for externally operating the computer program or application.

Another advantage of the invention is to provide a method and apparatus for external operation of the computer program or application, wherein the reader tray and the tag modules are communicated with each other via RFID (Radio Frequency Identification)/NFC (Near-Field Communication) connection.

Another advantage of the invention is to provide a method and apparatus for external operation of the computer program or application, wherein each of the tag modules pre-stores one or more tag information, such that the reader tray reads the tag information of the tag modules to generate the output signal for externally operating the computer program or application.

Another advantage of the invention is to provide a method and apparatus for external operation of the computer program or application, wherein each of the tag modules is powered by a power source of the reader tray when the tag module is placed on the reader tray, such that the tag modules do not require any power supply for operation.

Another advantage of the invention is to provide a method and apparatus for external operation of the computer program or application, wherein the reader tray has a plurality of identification areas to guide the tag modules being placed thereon to define the location sequence of said tag modules.

Another advantage of the invention is to provide a method and apparatus for external operation of the computer program or application, wherein the operation is simple and easy by placing the tag modules on the reader tray in sequence.

Another advantage of the invention is to provide a method and apparatus for external operation of the computer program or application, which can be applied to a toy to form an intelligent interactive toy for creating an interactive way to make the toy more interesting to learn.

Another advantage of the invention is to provide a method and apparatus for external operation of the computer program or application, wherein no expensive or complicated structure is required to employ the present invention in order to achieve the above mentioned objectives. Therefore, the present invention successfully provides an economic and efficient solution to create an interactive tool for the user especially for children to learn.

Additional advantages and features of the invention will become apparent from the description which follows, and may be realized by means of the instrumentalities and combinations particular point out in the appended claims.

According to the present invention, the foregoing and other objects and advantages are attained by an apparatus for external operation of a computer program or application installed into a computerized device, comprising:

a reader tray which has a plurality of identification areas and comprises a reader module and a communication module for communicatively connecting to the computerized device that stores and executes the computer program or application; and

one or more tag sets, each comprising a plurality of tag modules, wherein each of the tag modules stores one or more predetermined tag information, such that when the tag modules are selectively placed on the identification areas, the reader module reads the tag information of the tag modules to generate an output signal in response to a location sequence of the tag modules for operating the computer program or application through the communication module.

In accordance with another aspect of the invention, the present invention comprises a method for external operation of a computer program or application installed into a computerized device, comprising the following steps.

(A) Communicatively link a reader tray to the computerized device via a communication module of the reader tray.

(B) Provide a plurality of identification areas on the reader tray to hold a plurality of tag modules in position, wherein each of the tag modules stores one or more predetermined tag information.

(C) Read the tag information of the tag modules by a reader module of the reader tray.

(D) Generate an output signal in response to a location sequence of the tag modules for operating the computer program or application through the communication module.

In accordance with another aspect of the invention, the present invention comprises an intelligent interactive toy for a computerized device, comprising:

a toy application adapted for being installed into the computerized device, wherein the toy application is configured to generate a request signal;

a reader tray which has a plurality of identification areas and comprises a reader module, a computer holder for holding the computerized device in position, and a communication module for communicatively connecting to the computerized device that stores and executes the computer program or application; and

a plurality of tag modules, wherein each of the tag modules stores one or more predetermined tag information and are arranged in such a manner that in response to the request signal from the toy application, the tag modules are selectively placed on the identification areas, such that the reader module reads the tag information of the tag modules to generate an output signal in response to a location sequence of the tag modules for operating the toy application through the communication module.

Still further objects and advantages will become apparent from a consideration of the ensuing description and drawings.

These and other objectives, features, and advantages of the present invention will become apparent from the following detailed description, the accompanying drawings, and the appended claims.

### BRIEF DESCRIPTION OF THE DRAWINGS

FIG. 1 is perspective view of an apparatus for external operation of a computer program or application according to a preferred embodiment of the present invention, illustrating an intelligent interactive toy being incorporated with the apparatus for holding a computerized device.

FIG. 2 is a perspective view of a reading tray of the apparatus according to the above preferred embodiment of the present invention.

FIG. 3 is a block diagram of the reading tray of the apparatus according to the above preferred embodiment of the present invention.

FIG. 4 is a perspective view of tag modules of the apparatus according to the above preferred embodiment of the present invention.

FIG. 5 is a top sectional view of the tag module of the apparatus according to the above preferred embodiment of the present invention.

FIG. 6 is a side sectional view of the tag module of the apparatus according to the above preferred embodiment of the present invention.

FIG. 7 illustrates an alternative mode of the tag module of the apparatus according to the above preferred embodiment of the present invention.

FIG. 8 is a flow diagram illustrating a method for external operation of a computer program or application according to the above preferred embodiment of the present invention.

### DETAILED DESCRIPTION OF THE PREFERRED EMBODIMENT

The following description is disclosed to enable any person skilled in the art to make and use the present invention. Preferred embodiments are provided in the following description only as examples and modifications will be apparent to those skilled in the art. The general principles defined in the following description would be applied to other embodiments, alternatives, modifications, equivalents, and applications without departing from the spirit and scope of the present invention.

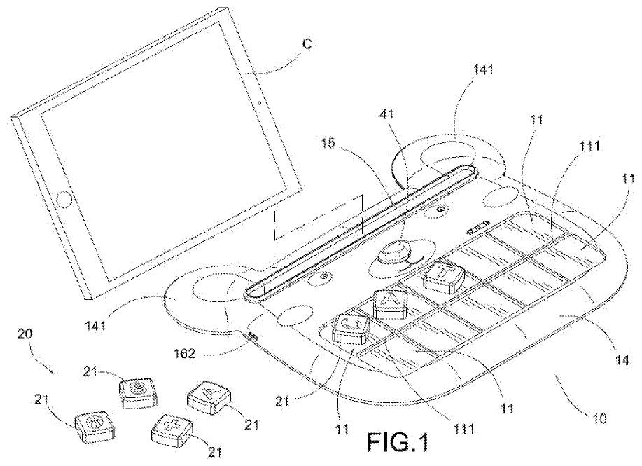

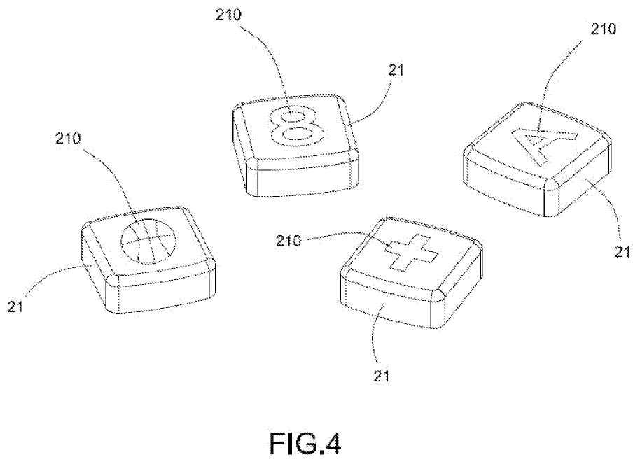

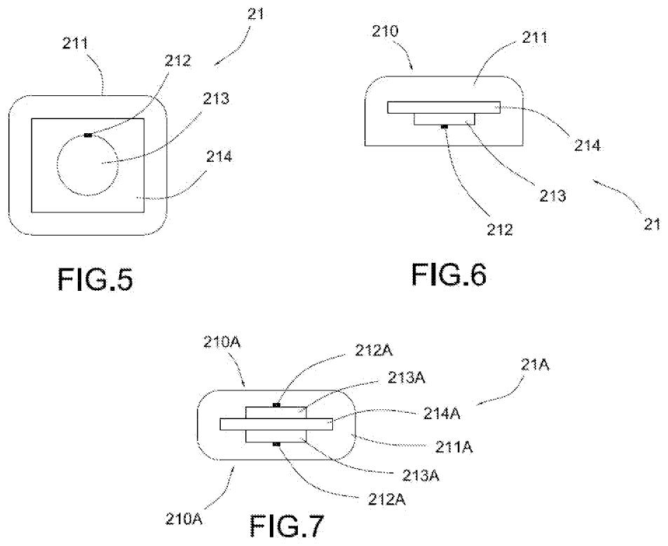

Referring to FIGS. 1 to 4 of the drawings, an apparatus for external operation of a computer program or application according to a preferred embodiment of the present invention is illustrated, wherein the computer program or application is installed into a computerized device C in order to communicatively link the apparatus of the present invention to the computerized device C. The computerized device C can be a smartphone, tablet computer, or smart television in which the computer program or application can be installed into the computerized device C and executed by a processor of the computerized device C. The apparatus of the present invention can be embodied as an intelligent interactive toy when the computer program or application is a toy application installed into the computerized device C.

As shown in FIGS. 1 to 4, the apparatus comprises a reader tray 10 and one or more tag sets 20 communicating with the reader tray 10 to operate the computer program or application installed into the computerized device C.

The reader tray 10, having a plurality of identification areas 11, comprises a reader module 12 and a communication module 13 for communicatively connecting to the computerized device C that stores and executes the computer program or application.

Each of the tag sets 20 comprises a plurality of tag modules 21, wherein each of the tag modules 21 stores one or more predetermined tag information, such that when the tag modules 21 are selectively placed on the identification areas 11, the reader module 12 reads the tag information of the tag modules 21 to generate an output signal in response to a location sequence of the tag modules 21 for operating the computer program or application through the communication module 13.

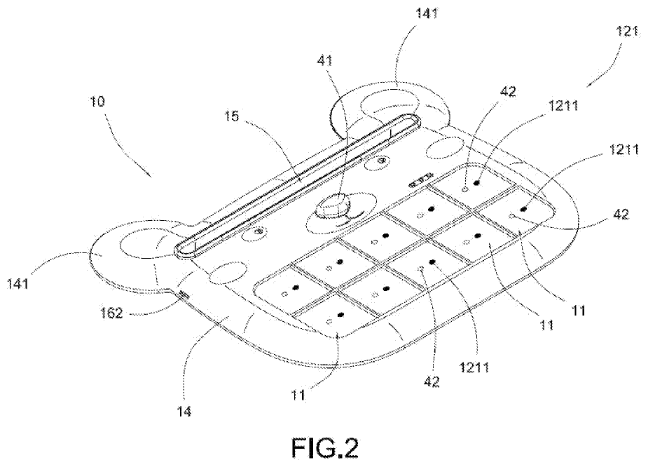

As shown in FIG. 2, the reader tray 10 further comprises a tray body 14 having a top side and a bottom side, wherein a plurality of indentions are spacedly formed on the top side thereon to form the identification areas 11 respectively. In other words, the identification areas 11 are spacedly formed on the top side of the tray body 14. In one embodiment, the identification areas 11 are identical and are arrayed to have at least one column configuration and at least one row configuration. As shown in FIG. 2, there are ten identification areas 11 arrayed in a 5×2 configuration, i.e. five identification areas 11 in a row and two identification areas 11 in a column, wherein each of the identification areas 11 has a square shape. Therefore, the identification areas 11 are positioned and aligned in sequence to lineup the tag modules 21 when the tag modules 21 are placed on the identification areas 11.

In addition, each of the identification areas 11 is indented on the top side of the tray body 14, wherein a guiding wall 111 is formed between every two of the identification areas 11. Therefore, the tag module 21 is blocked by the guiding wall 11 to prevent the tag module 21 being slid on the top side of the tray body 14 from one identification area 11 to the neighboring identification area 11. It is worth mentioning that a size of the tag module 21 is smaller than the identification area 11.

According to the preferred embodiment, the reader tray 10 further has a computer holder 15 formed on the tray body 14 for holding the computerized device C in position. In one embodiment, the computer holder 15 is a holding channel indented on the tray body 14 for holding the computerized device C in an upright manner. For example, when the computerized device C is embodied as a tablet computer, a peripheral edge of the tablet computer can be received at the holding channel of the computer holder, such that the tablet computer can be supported at an upright position with respect to the top side of the tray body 14. Preferably, the tablet computer is inclined and supported on the tray body 14 to provide an optimum viewing angle of the tablet computer. Accordingly, the identification areas 11 are formed at a front portion of the top side of the tray body 14 while the computer holder 15 is formed at a rear portion of the top side of the tray body 14. The tray body 14 further has a stabilization leg 141 rearwardly extended from a rear edge of the tray body 14 to support the computerized device C in a stabilized manner. In one embodiment, two stabilization legs 141 are integrally extended from two rear corners of the tray body 14 to keep a center of mass of the computerized device C within the tray body 14.

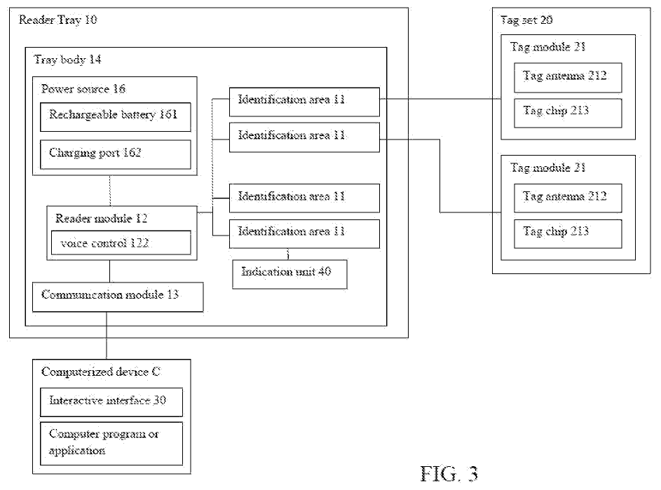

As shown in FIGS. 2 and 3, the reader module 12 is housed in the tray body 14, wherein the reader module 12 comprises a reader antenna array 121 wirelessly communicate with the tag module 21 to wirelessly receive the tag information of the tag module 21 only when the tag module 21 is placed on one of the identification areas 11 of the reading tray 10. In one embodiment, the reader antenna array 121 comprises a plurality of identification antennas 1211 located at the identification areas 11 respectively. In other words, one identification antenna 1211 is located at one identification area 11.

According to the preferred embodiment, the reader module 12 further comprises a voice control 122 for receiving a voice signal to operate the computer program or application. The voice signal is configured as the output signal transmitted from the reader module 12 to the computerized device C via the communication module 13.

The communication module 13 is housed in the tray body 14 and is communicatively linked to the reader module 12, wherein the communication module 13 is configured to wirelessly connect to the computerized device C via a communication connection. The communication connection can be a “Bluetooth” connection, “WiFi” connection, mobile connection or other wireless connections. It is worth mentioning that the communication module 13 comprises a communication port, such as USB, provided at the tray body 14, such that the communication module 13 can be connected to the computerized device C by connecting a cable at the communication port to the computerized device C.

The reader tray 10 further comprises a power source 16 housed in the tray body 15, wherein the power source 16 is electrically connected to the reader module 12 and the communication module 13. According to the preferred embodiment, the power source 16 comprises a rechargeable battery 161 housed in the tray body 15 and a charging port 162 provided at the tray body 15 for charging the rechargeable battery 161. Preferably, the power source 16 further comprises a charging protection circuit operatively connected to the rechargeable battery 161 for preventing the rechargeable battery 161 being overcharged.

In one embodiment, the tag modules 21 are communicatively linked to the reader module 12 via RFID (Radio Frequency Identification)/NFC (Near-Field Communication) connection. In other words, the tag module 21 is communicatively connected to the reader module 12 only when the tag module 21 is placed on one of the identification areas 11 of the reader tray 10.

According to the preferred embodiment, each of the tag modules 21 is a power-less module, wherein the power source 16 of the reader tray 10 is configured for electrically powering the tag modules 21 when the tag modules 21 are placed on the identification areas 11. Since the tag module 21 does not contain any power source or battery, the weight of the tag module 21 will be minimized. Each of the tag modules 21 comprises an outer tag housing 211, a tag antenna 212, and a tag chip 213 storing the tag information and operatively connecting to the tag antenna 212 to form a tag circuit unit sealed in the tag housing 211.

The reader antenna array 121 is wirelessly connected to the tag antenna 212 to wirelessly receive the tag information of the tag module 21 only when the tag module 21 is placed on one of the identification areas 11 of the reading tray 10. In other words, the identification antennas 1211 at the identification areas 11 are configured to wirelessly connect to the tag antennas 212 of the tag modules 21 when the tag modules 21 are placed on the identification areas 11. Therefore, the tag information of the tag module 21 is read by the corresponding identification antenna 1211 when the tag module 21 is placed on the corresponding identification area 11. Preferably, each of the tag modules 21 further comprises a circuit substrate 214 electrically connected to the tag circuit unit.

The tag sets 20 are configured to have two or more different sets, which can be an alphabet set, a symbol set, a number set, a word set, a thing set, a command set, and an action set.

The tag modules 21 in the alphabet set are alphabetic tag modules storing different alphabetic information, such as “A”, “B” . . . “Z”. When the alphabetic tag module “A” is placed on the identification area 11, the tag information of alphabet A is read by the corresponding identification antenna 1211. For example, when the alphabetic tag modules “C”, “A”, “T” are placed on the identification areas 11, the reader module 12 reads the tag information “C”, “A”, “T” to generate the corresponding output signal in response to the location sequence of the tag modules 21. Accordingly, the output signal containing a word “CAT” is generated to send to the computerized device C via the communication module 13 for operating the computer program or application. A corresponding character 210 is formed on the tag module 21. For example, when the tag module 21 stores the alphabetic “A” information, the character “A” 210 is provided on the surface of the tag module 21. The character 210 can be printed or engraved on surface of the tag module 21.

The tag modules 21 in the symbol set are symbol tag modules storing different symbol information, such as “+”, “−”, “*”, “/”, “=”, “%”, and the like. The tag modules 21 in the number set are numerical tag modules storing different numerical information, such as “0”, “1” . . . “9”. The tag modules in the word set are word tag modules storing different word information, such as “APPLE”, “BOY”, and the like. The tag modules in the thing set are thing tag modules storing different object information, such as “Table”, Chair“, and the like. The tag modules in the command set are command tag modules storing different command information, such as “send”, “enter”, and the like. The tag modules in the action set are action tag modules storing different action information, such as “punch”, “kick”, and the like. The tag set 20 can be an emoji tag set having different emoji tag modules storing different emojis information, can be a sport tag set having different sport tag modules storing different sport information, and/or can be a color tag set having different color tag modules storing different color information.

It is worth mentioning that a character of the corresponding tag information is printed on a top surface of the outer tag housing 211. Therefore, when the tag module 21 is placed on one of the identification areas 11 that the top surface of the outer tag housing 211 faces upward, the tag information is sent to the reader module 12.

FIG. 7 illustrates an alternative mode of the tag module 21A which comprises an outer tag housing 211A, two or more tag antennas 212A, and two or more tag chips 213A storing different tag information and operatively connecting to the tag antennas 212A to form two or more tag circuit units respectively. Each of the tag modules 21A further comprises a circuit substrate 214A electrically connected to the tag circuit units.

In one embodiment, two tag antennas 212A and two tag chips 213A are provided to form two tag circuit units. Accordingly, the circuit substrate 214A has a first side and an opposed second side, wherein the tag circuit units are coupled at the first and second sides of the circuit substrate 214A, such that the circuit substrate 214A serves as an insulating member to block the tag information being transmitted from one side of the circuit substrate 214A to the opposite side thereof.

The outer tag housing 211A has a first side and an opposed second side, wherein the first tag circuit unit is located close to the first side of the outer tag housing 211A and the second tag circuit unit is located close to the second side of the outer tag housing 211A. When the tag module 21A is placed on the identification area 11 at a position that the first side of the outer tag housing 211A faces upward, the first tag information is sent from the first tag antenna 212A to the reader module 12. Likewise, when the tag module 21A is placed on the identification area 11 at a position that the second side of the outer tag housing 211A faces upward, the second tag information is sent from the second tag antenna 212A to the reader module 12. For example, the first and second tag information can be alphabetic information and numerical information respectively. In other words, each tag module 21A can store two or more tag information and can send different tag information to the reader module 12 depending the face orientation of the tag module 21A on the identification area 11. It is worth mentioning that the characters 210 can be printed or engraved on two opposed surfaces of the tag module 21 for the corresponding first and second tag information respectively.

In order to communicatively link the apparatus of the present invention to the computerized device C, the apparatus further comprises an interactive interface 30 of a software adapted for being installed into the computerized device C to communicate with the computer software or application. The interactive interface 30 can be application programming interface (API) as a set of function to interact with the computer software or application and the computerized device C.

Accordingly, the output signal is sent to the interactive interface 30 via the communication module 13 for operating the computer software or application. In one embodiment, the interactive interface 30 is a control software or an add-on software to controllably operate the computer software or application. In order to operate the computer software or application, the interactive interface 30 is configured to send a request signal to the reader tray 10 and is configured to receive the output from the reader tray 10 via the communication module 13. In other words, the communication module 13 is wirelessly linked to the interactive interface 30 to form a wireless bridge for transmitting the output signal to the interactive interface 30 and for receiving the request signal from the computer software or application.

As shown in FIGS. 1 to 3, the reader tray 10 further comprises an indication unit 40 for indicating an operating status of the reader tray 10. The indication unit 40 comprises an operation button 41 provided at the top side of the tray body 14 at a position between the identification areas 11 and the computer holder 15. The operation button 41 is operatively connected to the reader module 12, the communication module 13, and the power source 16. In one embodiment, the operation button 41 is pressed to power on the reader module 12 and the communication module 13, and is pressed and held for a predetermined time, such as 3 seconds, to power off the reader module 12 and the communication module 13. Once the reader tray 10 is powered on, the operation button 41 is pressed to send the output signal to the computerized device C. In other words, after the tag modules 21 are placed on the identification areas 11 to gather the tag information for generating the output signal, the operation button 41 serves as a “send” button to transmit the output signal to the computerized device C. Therefore, the user is able to replace the tag modules 21 from other on the identification areas 11 or change the location sequence of the tag modules 21 before pressing the operation button 41.

The indication unit 40 further comprises a plurality of backlight elements 42 housed in the tray body 14 at the identification areas 11 respectively, wherein each of the backlight elements 42, such as a LED, is configured to illuminate the corresponding identification area 11. Accordingly, the backlight elements 42 can be programmed to have different configurations. In one configuration, all the backlight elements 42 are powered on once the reader tray 10 is switched on for illuminating the identification areas 11. In another configuration, the backlight elements 42 are powered on for illuminating the identification areas 11 when no tag module 21 is placed thereon. Once the tag module 21 is placed on one of the identification areas 11, the backlight element 42 at the corresponding identification area 11 is powered off. Likewise, the backlight elements 42 are powered off when no tag module 21 is placed thereon. Once the tag module 21 is placed on one of the identification areas 11, the backlight element 42 at the corresponding identification area 11 is powered on to indicate the tag module 21 on the corresponding identification area 11. It is appreciated that each of the backlight elements 42 is able to generate different colors to indicate whether there is a tag module 21 on the identification area 11. For example, the backlight element 42 will generate red color when no tag module 21 is placed on the identification area 11 and will generate blue color when the tag module 21 is placed on the corresponding identification area 11.

In one example, the apparatus of the present invention is configured to control a phone application installed into the computerized device C, such as a mobile phone. The interactive interface 30 is installed into the computerized device C to operate the phone application. When there is an incoming call, the user is able to place the tag module 21 having the tag information of “answer the call” on the identification area 11, such that the output signal having the tag information of “answer the call” will send to the computerized device C for answering the call. Likewise, when there is an incoming call, the user is able to place the tag module 21 having the tag information of “decline the call” on the identification area 11, such that the output signal having the tag information of “decline the call” will send to the computerized device C for declining the call. After answering the call, the user is able to hang up the call by removing the tag module 21 having the tag information of “hang up the call” on the identification area 11 or placing another tag module 21 having the tag information of “hang up the call” on another identification area 11.

Another example of the apparatus of the present invention is configured to control a music application installed into the computerized device C, such as a smart TV phone. The interactive interface 30 is installed into the computerized device C to operate the music application. The user is able to place the tag module 21 having the tag information of “volume up” on the identification area 11, such that the output signal having the tag information of “volume up” will send to the computerized device C for turning the volume up of the music. The user is able to place the tag module 21 having the tag information of “shuffle” on the identification area 11, such that the output signal having the tag information of “shuffle” will send to the computerized device C for shuffling the music.

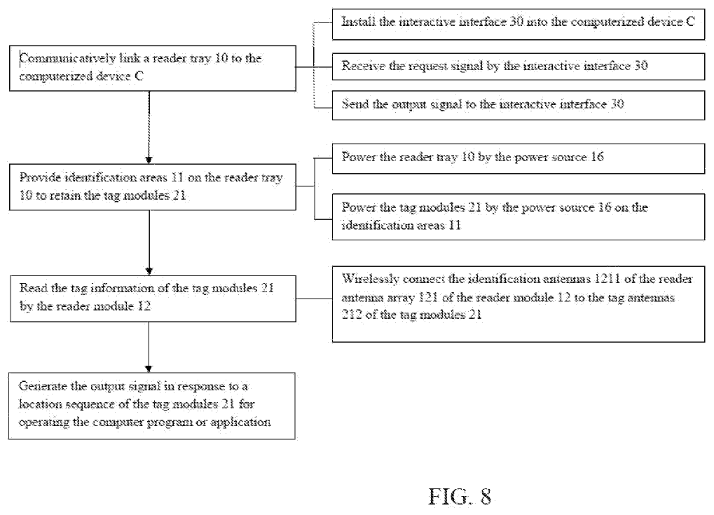

FIG. 8 illustrates a method for external operation of the computer program or application, which comprises the following steps.

(1) Communicatively link the reader tray 10 to the computerized device C via the communication module 13 of the reader tray 10. Preferably, the communication module 13 is a wireless communication unit, wherein the reader tray 10 and the computerized device C are connected wirelessly. For communicatively operating the computer program or application, the step (1) further comprises the following steps.

(1.1) Install the interactive interface 30 of the software into the computerized device C to communicate with the computer software or application.

(1.2) Receive the request signal from the computer software or application to the interactive interface 30.

(1.3) Send the output signal to the interactive interface 30 through the communication module 13 for operating the computer software or application.

Accordingly, the output signal is a feedback or a command of the request signal in response to the tag information of the location sequence of the tag modules 21.

(2) Provide a plurality of identification areas 11 on the reader tray 10 to hold a plurality of tag modules 21 in position, wherein each of the tag modules 21 stores one or more predetermined tag information. Accordingly, the user is able to selectively place any one of the tag modules 21 at the first identification area 11 and place another tag module 21 at the second identification area 11 to form the location sequence of the tag modules 21.

According to the preferred embodiment, the step (2) further comprises the following steps.

(2.1) Provide the power source 16 in the reader tray 10 to electrically connect to the reader module 12 and the communication module 13.

(2.2) Power the tag modules 21 by the power source 16 when the tag modules 21 are placed on the identification areas 11.

(3) Read the tag information of the tag modules 21 by the reader module 12 of the reader tray 10. Accordingly, the tag information is wirelessly transmitted from the tag module 21 to the reader tray 10, wherein the step (3) comprises the following steps.

(3.1) Provide the reader antenna array 121 of the reader module 12 in the reader tray 10. Preferably, a plurality of identification antennas 1211 of the reader antenna array 121 are located at the identification areas 11 respectively, such that the corresponding identification antenna 1211 will detect and connect the tag antenna 212 of the tag module 21 when the tag module 21 is placed on the corresponding identification area 11.

(3.2) Wirelessly connect the reader antenna array 121 to the tag antenna 212 of each of the tag modules 21 to wirelessly receive the tag information of the tag module 21 only when the tag module 21 is placed on one of the identification areas 11 of the reading tray 11. It is worth mentioning that the tag antennas 212 of the tag modules 21 are communicatively linked to the identification antennas 1211 of the reader antenna array 121 of the reader module 12 via RFID (Radio Frequency Identification)/NFC (Near-Field Communication) connection.

(4) Generate the output signal in response to the location sequence of the tag modules 21 for operating the computer program or application through the communication module 13.

According to the preferred embodiment, an application of the apparatus is to form an intelligent interactive toy as a software to be installed into the computerized device C. Accordingly, a toy application is configured for being installed into the computerized device C. In one embodiment, the toy application is an integrated application or program of the above mentioned computer program or application, and the interactive interface 30.

The intelligent interactive toy can be a mini electronic game to be installed into and executed by the computerized device C. For example, the electronic game can be a math game, wherein a math question, such as “5*7=?” is generated to be displayed on a display screen of the computerized device C. The corresponding request signal of the math question is generated from the toy application to the reader tray 10. Then, the user is able to place the tag module 21 having the tag information of “3” at the first identification area 11 and to place another tag module 21 having the tag information of “5” at the second identification area 11. The location sequence of the tag modules 21 are set to generate the output signal of “35” to the toy application as an answer of the math question. If the tag modules 21 are placed correctly to have the corrected answer, i.e. match with the preset signal, the toy application will generate a feedback signal. In other words, the feedback signal will indicate whether the output signal (answer) matching the preset signal (preset answer) or not.

One skilled in the art will understand that the embodiment of the present invention as shown in the drawings and described above is exemplary only and not intended to be limiting.

It will thus be seen that the objects of the present invention have been fully and effectively accomplished. The embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. An apparatus for external operation of a computer program or application installed into a computerized device, comprising:
a reader tray which has a plurality of identification areas and comprises a reader module and a communication module for communicatively connecting to the computerized device that stores and executes the computer program or application; and
one or more tag sets, each comprising a plurality of tag modules, wherein each of said tag modules stores one or more predetermined tag information, such that when said tag modules are selectively placed on said identification areas, said reader module reads said tag information of said tag modules to generate an output signal in response to a location sequence of said tag modules for operating the computer program or application through said communication module.

2. The apparatus, as recited in claim 1, wherein said tag modules are communicatively linked to said reader module via RFID (Radio Frequency Identification)/NFC (Near-Field Communication) connection.

3. The apparatus, as recited in claim 1, wherein said identification areas are positioned and aligned in sequence to lineup said tag modules when said tag modules are placed on said identification areas.

4. The apparatus, as recited in claim 1, wherein each of said tag modules, which is a power-less module, comprises an outer tag housing, a tag antenna, and a tag chip storing said tag information and operatively connecting to said tag antenna to form a tag circuit unit sealed in said tag housing.

5. The apparatus, as recited in claim 4, wherein said reader module comprises a reader antenna array wirelessly connected to said tag antenna to wirelessly receive said tag information of said tag module only when said tag module is placed on one of said identification areas of said reading tray.

6. The apparatus, as recited in claim 5, wherein said reader antenna array comprises a plurality of identification antennas located at said identification areas respectively.

7. The apparatus, as recited in claim 1, wherein said reader tray further comprises a power source electrically connected to said reader module and said communication module, and electrically powering said tag modules when said tag modules are placed on said identification areas.

8. The apparatus, as recited in claim 1, further comprising an interactive interface of a software adapted for being installed into the computerized device to communicate with the computer software or application, wherein said output signal is sent to said interactive interface via said communication module for operating the computer software or application.

9. The apparatus, as recited in claim 8, wherein said communication module is wirelessly linked to said interactive interface to form a wireless bridge for transmitting said output signal to said interactive interface and for receiving a request signal from the computer software or application.

10. The apparatus, as recited in claim 1, wherein said tag sets are configured to have at least two of an alphabet set, a symbol set, a number set, a word set, a thing set, a command set, and an action set, wherein said tag modules in said alphabet set are alphabetic tag modules storing different alphabetic information, wherein said tag modules in said symbol set are symbol tag modules storing different symbol information, wherein said tag modules in said number set are numerical tag modules storing different numerical information, wherein said tag modules in said word set are word tag modules storing different word information, wherein said tag modules in said thing set are thing tag modules storing different object information, wherein said tag modules in said command set are command tag modules storing different command information, and wherein said tag modules in said action set are action tag modules storing different action information.

11. A method for external operation of a computer program or application installed into a computerized device, comprising the steps of:
(a) communicatively linking a reader tray to the computerized device via a communication module of said reader tray;
(b) providing a plurality of identification areas on said reader tray to hold a plurality of tag modules in position, wherein each of said tag modules stores one or more predetermined tag information;
(c) reading said tag information of said tag modules by a reader module of said reader tray; and
(d) generating an output signal in response to a location sequence of said tag modules for operating the computer program or application through said communication module.

12. The method as recited in claim 11, in the step (c), wherein said tag modules are communicatively linked to said reader module via RFID (Radio Frequency Identification)/NFC (Near-Field Communication) connection.

13. The method, as recited in claim 11, wherein the step (c) further comprises the steps of:
(c.1) providing a reader antenna array of said reader module in said reader tray; and
(c.2) wirelessly connecting said reader antenna array to a tag antenna of each of said tag modules to wirelessly receive said tag information of said tag module only when said tag module is placed on one of said identification areas of said reading tray.

14. The method as recited in claim 13 wherein, in the step (c.1), said reader antenna array comprises a plurality of identification antennas located at said identification areas respectively.

15. The method, as recited in claim 11, wherein the step (b) further comprises the steps of:
(b.1) providing a power source in said reader tray to electrically connect to said reader module and said communication module; and
(b.2) powering said tag modules by said power source when said tag modules are placed on said identification areas.

16. The method, as recited in claim 11, wherein the step (a) further comprises the steps of:
(a.1) installing an interactive interface of a software into the computerized device to communicate with the computer software or application;
(a.2) receiving a request signal from the computer software or application to said interactive interface; and
(a.3) sending said output signal to said interactive interface through said communication module for operating the computer software or application.

17. The method, as recited in claim 11, wherein said tag modules are grouped to form a plurality of tag sets which are at least two of an alphabet set, a symbol set, a number set, a word set, a thing set, a command set, and an action set, wherein said tag modules in said alphabet set are alphabetic tag modules storing different alphabetic information, wherein said tag modules in said symbol set are symbol tag modules storing different symbol information, wherein said tag modules in said number set are numerical tag modules storing different numerical information, wherein said tag modules in said word set are word tag modules storing different word information, wherein said tag modules in said thing set are thing tag modules storing different object information, wherein said tag modules in said command set are command tag modules storing different command information, and wherein said tag modules in said action set are action tag modules storing different action information.

18. An intelligent interactive toy for a computerized device, comprising:
a toy application adapted for being installed into the computerized device, wherein said toy application is configured to generate a request signal;
a reader tray which has a plurality of identification areas and comprises a reader module, a computer holder for holding the computerized device in position, and a communication module for communicatively connecting to the computerized device that stores and executes the computer program or application; and
a plurality of tag modules, wherein each of said tag modules stores one or more predetermined tag information and are arranged in such a manner that in response to said request signal from said toy application, said tag modules are selectively placed on said identification areas, such that said reader module reads said tag information of said tag modules to generate an output signal in response to a location sequence of said tag modules for operating said toy application through said communication module.

19. The intelligent interactive toy, as recited in claim 18, wherein said computer holder comprises a holding channel for holding a tablet computer as said computerized device in an upright manner.

20. The intelligent interactive toy, as recited in claim 18, wherein said reader tray has a plurality of indentions spacedly formed on a top side thereon to form said identification areas respectively.

21. The intelligent interactive toy, as recited in claim 18, wherein said toy application comprises an interactive interface to sent said request signal to said reader module and to receive said output signal from said reader module via said communication module.

22. The intelligent interactive toy, as recited in claim 18, wherein at least one of said tag modules has a first side and an opposed second side, when said tag module is disposed at one of said identification areas at a position said first side of said tag module faces up, said reader module reads said tag information of said tag modules as a first information, and when said tag module is disposed at said identification area at a position said second side of said tag module faces up, said reader module reads said tag information of said tag modules as a second information, such that said tag module stores two different tag information.

23. The intelligent interactive toy, as recited in claim 18, wherein said tag modules are grouped to form a plurality of tag sets which are at least two of an alphabet set, a symbol set, a number set, a word set, a thing set, a command set, and an action set, wherein said tag modules in said alphabet set are alphabetic tag modules storing different alphabetic information, wherein said tag modules in said symbol set are symbol tag modules storing different symbol information, wherein said tag modules in said number set are numerical tag modules storing different numerical information, wherein said tag modules in said word set are word tag modules storing different word information, wherein said tag modules in said thing set are thing tag modules storing different object information, wherein said tag modules in said command set are command tag modules storing different command information, and wherein said tag modules in said action set are action tag modules storing different action information.

24. The intelligent interactive toy, as recited in claim 18, wherein said tag modules are communicatively linked to said reader module via RFID (Radio Frequency Identification)/NFC (Near-Field Communication) connection.

25. The intelligent interactive toy, as recited in claim 18, wherein said reader tray further comprises a power source electrically connected to said reader module and said communication module, and electrically powering said tag modules when said tag modules are placed on said identification areas.
